(19) United States
(12) Patent Application Publication
(10) Pub. No.: US 2008/0232456 A1
(43) Pub. Date: Sep. 25, 2008

(54) ENCODING APPARATUS, ENCODING METHOD, AND COMPUTER READABLE STORAGE MEDIUM STORING PROGRAM THEREOF

(75) Inventors: Yoshihiro TERASHIMA, Fukuoka (JP); Yoshiteru TSUCHINAGA, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/040,200

(22) Filed: Feb. 29, 2008

(30) Foreign Application Priority Data
Mar. 19, 2007 (JP) 2007-071655

(51) Int. Cl. H04B 1/66

(52) U.S. Cl. 375/240; 375/E07.026

(57) ABSTRACT

An encoding apparatus holds predetermined encoding conditions (sets of a sampling frequency and a bit rate) associated with predetermined ranges having consecutive possible amounts of free space in the storage 20. A set of a sampling frequency and a bit rate associated with a range corresponding to a current free capacity is selected, and sound data included in a music file generated from an original digital signal data is encoded under the encoding condition by using a predetermined encoding software. By comparing sound data restored from the encoded data and sound data included in a music file, evaluation value is calculated with an evaluation method such as PEAQ, and it is determined whether the evaluation value exceeds a threshold value. The encoded data is stored in the storage when the evaluation value exceeds the threshold value.

### BACKGROUND OF THE INVENTION

1. Field of the Invention

The present invention relates to an encoding apparatus, particularly to an encoding apparatus which automatically adjusts a condition for encoding.

2. Description of the Related Art

There is an encoding apparatus for encoding contents such as sound data or image data with a predetermined encoding method and storing the encoded data. For example, a personal computer extracts, as a music file, digital signal data of audio-waveform recorded on a music CD (compact disc) by using software called a “ripper”, encodes the sound data included in the music file into MP3 (MPEG (Moving Picture Experts Group) Audio Layer-3) format or the like by using an encoder, and stores the encoded data.

In such an encoding apparatus, an encoder performs encoding under a certain encoding condition. Some encoding apparatuses receive an arbitrary encoding condition from a user, and other encoding apparatuses hold an encoding condition preset. In either case, it is important how to set an encoding condition to use a storage capacity of the encoding apparatus efficiently.

For example, Japanese Unexamined Patent Application Publication No. 2005-316499 discloses a technology for using a storage capacity efficiently. According to the disclosed technology, in a mobile terminal performing telephone answering service, sound data received by the telephone answering service is analyzed to determine whether it was generated during a speech period or whether it was generated during a non-speech period. The sound data is encoded and stored as audio packets in a storage while each of the audio packets is associated with a level of importance among several levels in accordance with the result of the analysis. When an amount of free space in the storage decreases, audio packets associated with lower levels of importance are further compressed and encoded.

In the case of the encoding apparatus that receives an arbitrary encoding condition from the user, the user himself must determine the encoding condition by taking into account the amount of free space in the storage. Accordingly, there is a problem in that such operation of determination requires effort. In the case of the encoding apparatus which holds an encoding condition preset, there is no flexibility in encoding since the encoding condition cannot be changed even when all portions of the digital signal data can be stored in the free space in the storage by simply changing the encoding condition while ensuring quality that is good enough to be ordinarily appreciated. Further, in the technology disclosed in Japanese Unexamined Patent Application Publication No. 2005-316499, the encoded information becomes more compressed as the amount of free space decreases. Thus, a problem occurs in that quality that is good enough to be appreciated cannot always be ensured.

### SUMMARY

The present invention has been made in order to solve the above-described problems in the related art. It is an object of the present invention to provide an encoding apparatus which can simply and flexibly conform to an amount of free space in a storage and perform encoding while ensuring quality that is good enough to be appreciated.

According to a first aspect of the present invention, there is provided an encoding apparatus which encodes contents. The encoding apparatus includes: a content storage which stores encoded contents which are generated by encoding the contents, a condition storage which stores conditions corresponding to amounts of free space in the content storage, an input unit which inputs a content, a condition selector which retrieves a current condition from among the conditions which are stored in the condition storage, wherein the current condition corresponds to a current free capacity which is an amount of free space currently available in the content storage, an encoder which encodes the content under the current condition, a restorer which restores a content from the encoded content, an evaluator which evaluates the restored content and determines whether the evaluation result exceeds a predetermined threshold, and a manager which stores the encoded content in the content storage when the evaluation result exceeds the predetermined threshold.

The encoding apparatus may further include an analyzer which determines a frequency domain of the content. In such a configuration, the conditions which are stored in the condition storage also correspond to frequency domains of contents, and the condition selector retrieves a current condition which corresponds also to the frequency domain of the content.

The encoder of the encoding apparatus may encode the content with a plurality of encoding methods. In such a configuration, the restorer restores a plurality of contents from a plurality of the encoded contents, the evaluator evaluates a plurality of the restored contents and determines whether all the evaluation results exceed the predetermined threshold, and the manager stores in the content storage an encoded content which corresponds to a restored content with a highest evaluation result when all the evaluation results exceed the predetermined threshold.

The predetermined threshold in the encoding apparatus may vary in accordance with the current free capacity.

The encoding apparatus may further include a condition updater which updates the current condition. The update may include adjustment of the current condition as to increase a quality of the restored content when the evaluation result is within the predetermined threshold. The update may include adjustment of the current condition as to decrease the quality of the restored content when the evaluation result exceeds the predetermined threshold in an initial determination. In such a configuration, the encoder encodes the content under the updated current condition when the evaluation result is within the predetermined threshold.

According to a second aspect of the present invention, there is provided a computer readable storage medium which stores a program of instructions to a computer to execute an encoding method for encoding contents. The computer includes a content storage which stores encoded contents which are generated by encoding the contents and a condition storage which stores conditions which correspond to amounts of free space in the content storage. The encoding method includes the steps of: inputting a content, retrieving a current condition from among the conditions which are stored in the condition storage, wherein the current condition corresponds to a current free capacity which is an amount of free space currently available in the content storage, encoding the content under the current condition, restoring a content from the encoded content, evaluating the restored content, determining whether the evaluation result exceeds a predetermined threshold, and storing the encoded content in the content storage when the evaluation result exceeds the predetermined threshold.

According to a third aspect of the present invention, there is provided an encoding method which is executed by an encoding apparatus which encodes contents. The encoding apparatus includes a content storage which stores encoded contents which are generated by encoding the contents and a condition storage which stores conditions which correspond to amounts of free space in the content storage. The encoding method includes the steps of: inputting a content, retrieving a current condition from among the conditions which are stored in the condition storage, wherein the current condition corresponds to a current free capacity which is an amount of free space currently available in the content storage, encoding the content under the current condition, restoring a content from the encoded content, evaluating the restored content, determining whether the evaluation result exceeds a predetermined threshold, and storing the encoded content in the content storage when the evaluation result exceeds the predetermined threshold.

According to the aspects of the present invention, encoding conditions corresponding to amounts of free space in a storage for storing encoded contents are held and a content is encoded under an encoding condition determined on the basis of a current free capacity that is an amount of free space currently available in the storage. Restored content which is restored from the encoded content is evaluated, and it is determined whether the evaluation result exceeds a predetermined threshold value. The encoded content is stored in the storage when the evaluation result is determined to exceed the predetermined threshold value. Thus, an encoding which conforms to the amount of free space in the storage can be simply and flexibly performed while ensuring quality that is good enough to be appreciated.

### BRIEF DESCRIPTION OF THE DRAWINGS

FIG. 1 is a diagram illustrating an overview and features of an encoding apparatus according to a first embodiment of the present invention;

FIG. 2 is a block diagram illustrating a configuration of an encoding apparatus according to the first embodiment of the present invention;

FIG. 3 is a diagram illustrating examples of information stored in a condition table storage;

FIG. 4 is a diagram illustrating examples of information stored in a group table storage;

FIG. 5 is a diagram illustrating examples of information stored in a threshold table storage;

FIG. 6 is a flowchart illustrating a flow of a process of an encoding apparatus according to the first embodiment of the present invention;

FIG. 7 is a block diagram illustrating a configuration of an encoding apparatus according to a second embodiment of the present invention; and

FIG. 8 is a block diagram illustrating a computer for executing an encoding program according to an embodiment of the present invention.

### DESCRIPTION OF THE PREFERRED EMBODIMENTS

Embodiments of the present invention will be described in detail with reference to the accompanying drawings.

### First Embodiment

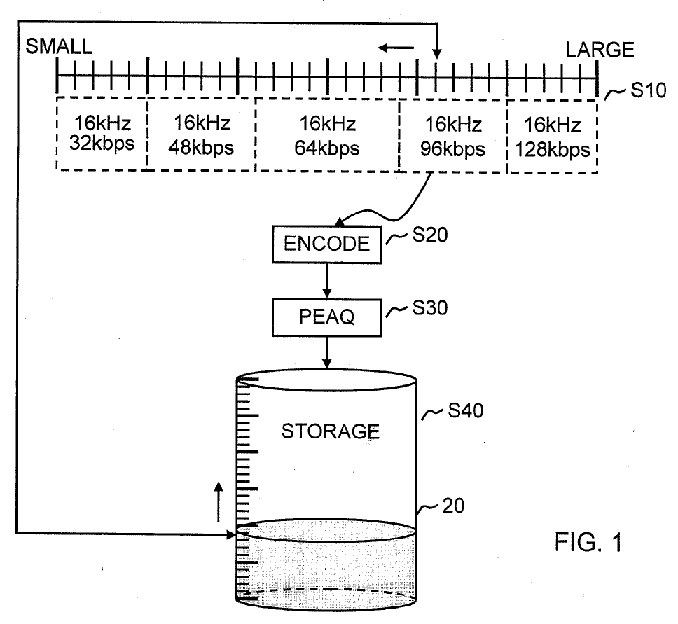

FIG. 1 is a diagram illustrating an overview and features of an encoding apparatus according to a first embodiment of the present invention. The overview and the features of the encoding apparatus according to the first embodiment will be described with reference to FIG. 1.

The overview of the encoding apparatus according to the first embodiment of the present invention is that sound data which is originally recorded on a CD-DA (compact disc digital audio) as digital signal data is encoded with a predetermined encoding method and the encoded data is stored. This encoding apparatus has a main feature in that it can perform encoding while simply and flexibly conforming to an amount of free space in a storage and ensuring quality that is good enough to be appreciated.

The main feature will be described below. The encoding apparatus holds encoding conditions corresponding to amounts of free space in a storage 20. Specifically, as shown in FIG. 1, the encoding apparatus holds predetermined conditions (sets of a sampling frequency and a bit rate) associated with predetermined ranges having consecutive possible amounts of free space in the storage 20. Here, it is preferable that, as the value of the amount of free space in the storage 20 decreases, a condition (a set of a sampling frequency and a bit rate) having lower values be associated with a corresponding range. In FIG. 1, for convenience of description, a position indicated by one end of a bidirectional arrow on a scale shown in an upper portion of FIG. 1 corresponds to a current free capacity that is an amount of free space currently available in the storage 20. The other end of the bidirectional arrow indicates a value on a scale of the storage 20. Upon storing the encoded data in the storage 20, positions indicated by both ends of the bidirectional arrow move in the directions of unidirectional arrows. In addition, conditions (sets of a sampling frequency and a bit rate) are associated with predetermined ranges of consecutive values on the scale in an upper portion of FIG. 1.

The encoding apparatus determines an encoding condition corresponding to the current free capacity. Specifically, as shown in step S10 of FIG. 1, since the current free capacity is in a range including the position indicated by one end of the bidirectional arrow, the encoding apparatus determines an encoding condition by selecting a set of a sampling frequency and a bit rate associated with the range (for example, the sampling frequency “16 kHz” and the bit rate “96 kbps”). Although FIG. 1 represents a concept of one of techniques for determining an encoding condition corresponding to the current free capacity, the determination method is not limited to the technique shown in FIG. 1.

The encoding apparatus encodes a content to be encoded under the determined encoding condition. Specifically, as shown in step S20 of FIG. 1, the encoding apparatus generates encoded data by encoding sound data which is originally recorded on a CD-DA as digital signal data under the determined encoding condition by using predetermined encoding software.

The encoding apparatus evaluates sound data restored from the encoded data with an evaluation method considering human subjectivity, and determines whether the result of evaluation exceeds a predetermined threshold value. Specifically, as shown in step S30 of FIG. 1, the encoding apparatus calculates an evaluation value by comparing sound data restored from the encoded data which is encoded by the encoding software and sound data included in a music file generated from the digital signal data recorded on the CD-DA by using software capable of the PEAQ (Perceived Evaluation of Audio Quality) evaluation, and determines whether the evaluation value exceeds a predetermined threshold value.

The encoding apparatus stores the encoded data in the storage 20 only when the evaluation value exceeds the predetermined threshold value. Specifically, as shown in step S40 of FIG. 1, the encoding apparatus stores the encoded data in the storage 20 when the evaluation value resulted from the PEAQ evaluation exceeds the predetermined threshold value. Here, it is preferable that the threshold value be a value capable of ensuring quality that is good enough to be appreciated. When storing of the encoded data in the storage 20 changes the position, indicated by the bidirectional arrow on each scale, to a different range from the present range, a corresponding set of a sampling frequency and a bit rate also changes.

Therefore, the encoding apparatus can simply and flexibly conform to an amount of free space in a storage and perform encoding while ensuring quality that is good enough to be appreciated.

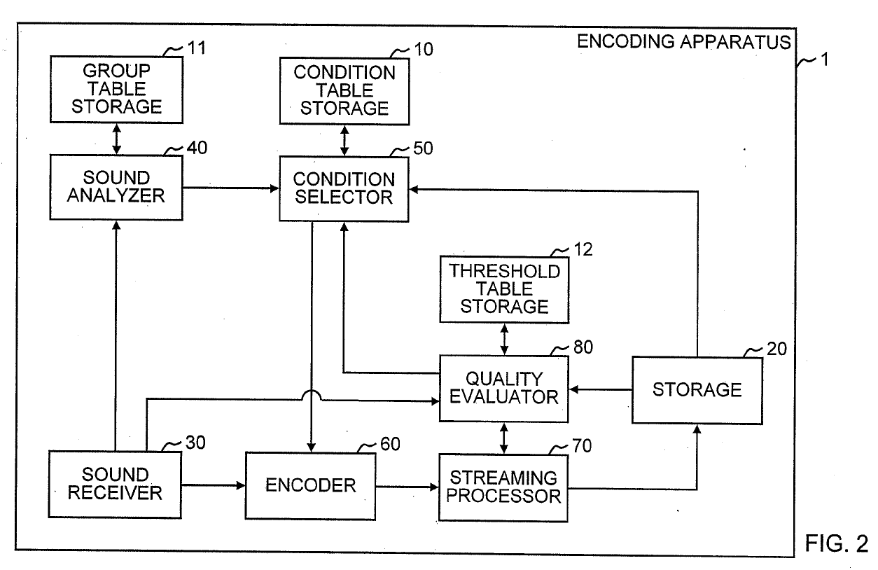

FIG. 2 is a block diagram illustrating a configuration of an encoding apparatus according to the first embodiment of the present invention. The configuration of the encoding apparatus described in FIG. 1 will be described below with reference to FIG. 2.

As shown in FIG. 2, an encoding apparatus 1 includes a condition table storage 10, a storage 20, a sound receiver 30, a sound analyzer 40, a group table storage 11, a condition selector 50, an encoder 60, a streaming processor 70, a quality evaluator 80, and a threshold table storage 12.

The storage 20 stores the encoded data. Specifically, the storage 20 receives the encoded data from the streaming processor 70 (described later) and stores the encoded data. The amount of free space in the storage 20 decreases by the amount of encoded data stored in the storage 20, and a current free capacity representing a current value of the amount of free space in the storage 20 also varies. The current free capacity is referred to by the condition selector 50 and the quality evaluator 80, which will be described later.

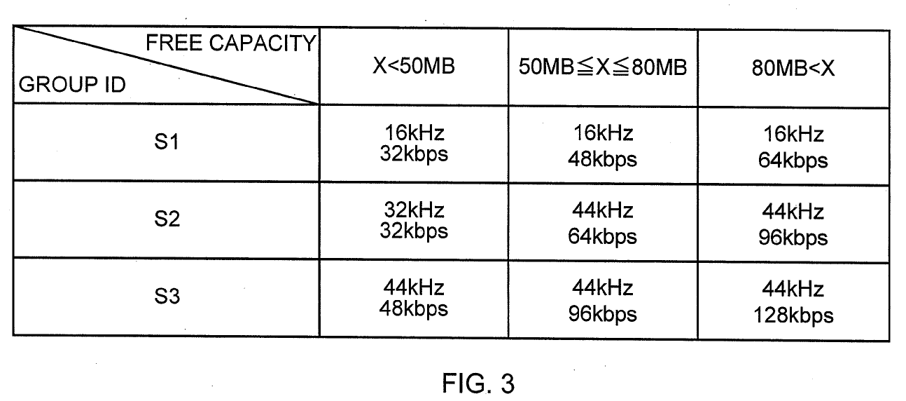

The condition table storage 10 stores encoding conditions corresponding not only to amounts of free space in the storage 20 for storing the encoded data but also to frequency domains of the content to be encoded. FIG. 3 is a diagram illustrating examples of information stored in a condition table storage. As shown in FIG. 3, the condition table storage 10 stores a condition table. The condition table is a matrix in which a group ID is associated with each row of the matrix and a range of a current free capacity is associated with each column of the matrix. In the condition table, sets of a sampling frequency and a bit rate are embedded in the cells of the matrix. For example, as shown in FIG. 3, the condition table storage 10 stores a condition table in which a set of the sampling frequency “32 kHz” and the bit rate “32 kbps” are embedded in a cell associated with the group ID “S2” and the range of a current free capacity X “X<50 MB”.

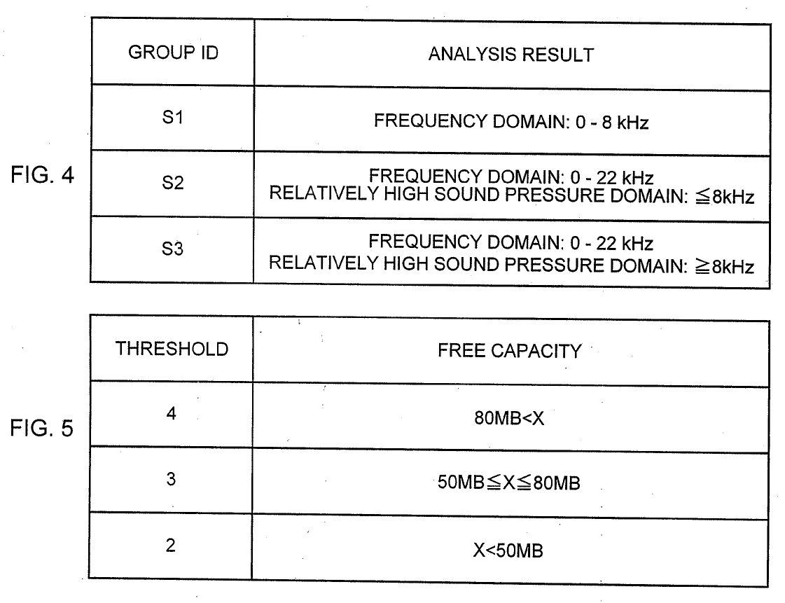

The group table storage 11 stores a group table referred to by the sound analyzer 40 (described later) to determine a group ID. FIG. 4 is a diagram illustrating examples of information stored in a group table storage. As shown in FIG. 4, the group table storage 11 stores a group table in which group IDs and information representing analysis results are associated with each other. For example, as shown in FIG. 4, the group table storage 11 stores a group table in which the group ID “S2” is associated with the analysis result “the frequency domain is 0 to 22 kHz and frequencies equal to or less than 8 kHz are distributed with a relatively high sound pressure”.

The threshold table storage 12 stores a threshold table for determining a threshold value used by the quality evaluator 80 (described later) to compare with an evaluation value. FIG. 5 is a diagram illustrating examples of information stored in a threshold table storage. As shown in FIG. 5, the threshold table storage 12 stores a threshold table in which threshold values are associated with ranges of a current free capacity. For example, as shown in FIG. 5, the threshold table storage 12 stores a threshold table in which the threshold value “4” is associated with the range of a current free capacity X “80 MB<X”.

The sound receiver 30 generates a music file including sound data from the digital signal data recorded on the CD-DA which is in a loaded state. Specifically, when the CD-DA is loaded, the sound receiver 30 reads digital signal data recorded on the CD-DA and generates a music file in a WAVE format or the like. The sound receiver 30 outputs the generated music file to the sound analyzer 40, the encoder 60, and the quality evaluator 80, which are described later.

The sound analyzer 40 performs a frequency analysis on the sound data included in the music file. Specifically, upon receiving the music file from the sound receiver 30, the sound analyzer 40 analyzes frequencies included in audio by performing Fourier transformation or the like, on the basis of the sound data included in the music file. The sound analyzer 40 reads a group ID corresponding to an analysis result from the group table stored in the group table storage 11, and outputs the read group ID to the condition selector 50 (described later). For example, the sound analyzer 40 analyzes a frequency domain that is a range from the lowest frequency to highest frequency included in all sounds appearing from the beginning to end of the audio, and the sound pressure at each frequency. When the frequency domain is “0 to 22 kHz” and frequencies equal to or less than 8 kHz are distributed with a relatively high sound pressure, the sound analyzer 40 reads the group ID “S2” from the group table and outputs the read group ID “S2” to the condition selector 50.

The condition selector 50 determines an encoding condition by selecting an encoding condition corresponding to the current free capacity in the storage 20 and the frequency domain of the content from the condition table. Specifically, upon receiving the group ID from the sound analyzer 40, the condition selector 50 acquires the current free capacity from the storage 20 and specifies a cell corresponding to the group ID and the current free capacity in the condition table stored in the condition table storage 10. The condition selector 50 reads a set of a sampling frequency and a bit rate embedded in the specified cell and outputs the set to the encoder 60 (described later). For example, when the condition selector 50 receives the group ID “S2” from the sound analyzer 40 and acquires the current free capacity “40 MB” from the storage 20 then the condition selector 50 reads a set of the sampling frequency “32 kHz” and the bit rate “32 kbps” and outputs the set to the encoder 60.

When the quality evaluator 80 determines that the predetermined threshold value is not exceeded, the condition selector 50 adjusts the encoding condition so that the quality increases. When the quality evaluator 80 determines that the predetermined threshold value is exceeded in an initial determination, the condition selector 50 adjusts the encoding condition so that the quality decreases. Specifically, upon receiving an instruction to update the encoding condition from the quality evaluator 80, the condition selector 50 updates the encoding condition embedded in a cell (from which the selected encoding condition has been actually read) by a predetermined amount so that the quality increases or decreases. For example, when the condition selector 50 receives, from the quality evaluator 80, a signal instructing the condition selector 50 to update the encoding condition embedded in the cell from which the selected encoding condition has been actually read so that the quality increases, in FIG. 3, a set of the sampling frequency “32 kHz” and the bit rate “32 kbps” that is embedded in the cell associated with the group ID “S2” and the range of a current free capacity X “X<50 MB” are updated into a set of the sampling frequency “32 kHz” and a bit rate “48 kbps”.

The encoder 60 encodes the content to be encoded under the determined encoding condition. When the quality evaluator 80 determines that the predetermined threshold value is not exceeded, the encoder 60 encodes the content again under the encoding condition updated by the condition selector 50. Specifically, upon receiving a set of a sampling frequency and a bit rate from the condition selector 50, the encoder 60 encodes the sound data included in the music file received from the sound receiver 30 and outputs the encoded data to the streaming processor 70 (described later). In addition, upon receiving an updated set of a sampling frequency and a bit rate from the condition selector 50, the encoder 60 encodes the sound data included in the music file received from the sound receiver 30 again under the updated encoding condition and outputs the encoded data to the streaming processor 70.

The streaming processor 70 stores, in the storage 20, encoded data only when the evaluation value is determined to exceed the predetermined threshold value. Specifically, upon receiving the encoded data from the encoder 60, the streaming processor 70 outputs sound data restored from the received data to the quality evaluator 80. Upon being instructed by the quality evaluator 80 to perform storing, the streaming processor 70 stores the encoded data actually used for sound data restoration in the storage 20.

The quality evaluator 80 evaluates sound data restored from the encoded data with an evaluation method considering human subjectivity, and determines whether the result of evaluation exceeds a predetermined threshold value. The quality evaluator 80 performs determination while changing the threshold value depending on the current free capacity.

Specifically, upon receiving sound data from the streaming processor 70, the quality evaluator 80 calculates an evaluation value in the PEAQ evaluation on the basis of the sound data included in the music file received from the sound receiver 30. For example, five-level evaluation is used and an evaluation value representing the least deterioration from the sound data included in the music file generated from the digital signal data recorded on the CD-DA is represented by “5”. The quality evaluator 80 acquires the current free capacity from the storage 20, determines a threshold value from the threshold table stored in the threshold table storage 12, and compares the calculated evaluation value with the threshold value. When the evaluation value exceeds the threshold value, the quality evaluator 80 outputs, to the condition selector 50, a signal instructing the condition selector 50 to update the encoding condition embedded in the cell from which the selected encoding condition has been actually read so that the quality decreases. The quality evaluator 80 also outputs, to the streaming processor 70, a signal instructing the streaming processor 70 to store the encoded data actually used for sound data restoration in the storage 20. When the evaluation value is equal to or less than the threshold value, the quality evaluator 80 outputs, to the condition selector 50, a signal instructing the condition selector 50 to update the encoding condition embedded in the cell from which the selected encoding condition has been actually read so that the quality increases.

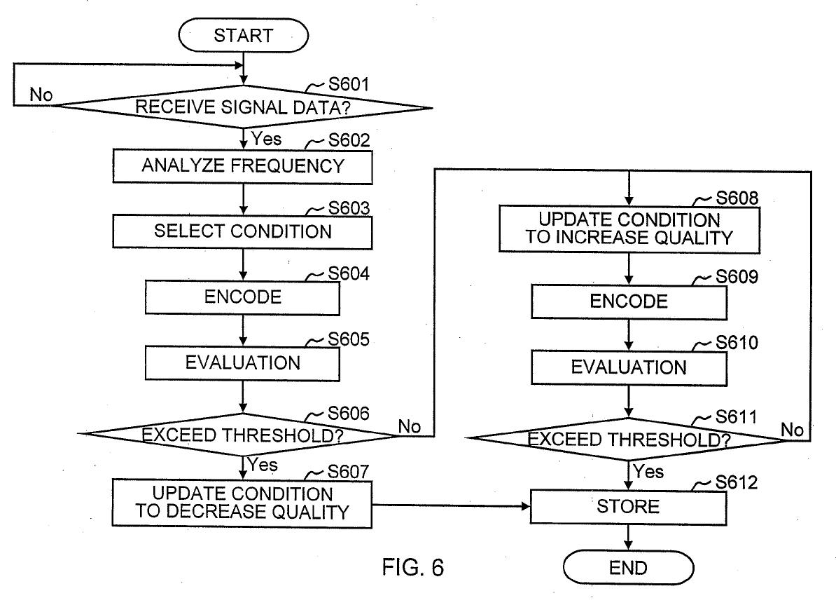

FIG. 6 is a flowchart illustrating a flow of a process of an encoding apparatus according to the first embodiment of the present invention. The process of the encoding apparatus 1 will be described below with reference to FIG. 6.

In step S601, the sound receiver 30 receives the digital signal data recorded on the CD-DA and generates a music file including sound data on the basis of the digital signal data. In step S602, frequencies of the sound data included in the music file are analyzed by the sound analyzer 40. In step S603, the condition selector 50 selects an encoding condition on the basis of the group ID determined by the sound analyzer 40 and the current free capacity of the storage 20.

In step S604, the encoder 60 encodes the sound data included in the music file under the encoding condition selected by the condition selector 50. In step S605, sound data restored from the encoded data is evaluated with the PEAQ evaluation method by the quality evaluator 80. In step S606, it is determined whether an evaluation value obtained by the evaluation exceeds a threshold value determined in accordance with the current free capacity of the storage 20.

If the quality evaluator 80 determines in an initial determination that the evaluation value exceeds the threshold value (Yes in step S606), in step S607, the encoding condition embedded in the cell (from which the selected encoding condition has been actually read) in the condition table is updated by the condition selector 50 so that quality decreases. In step S612, the encoded data is stored in the storage 20.

Alternatively, if the quality evaluator 80 determines that the evaluation value is equal to or less than the threshold value (No in step S606), in step S608, the encoding condition embedded in the cell (from which the selected encoding condition has been actually read) in the condition table is updated by the condition selector 50 so that the quality increases. In step S609, the sound data included in the music file is encoded again by the encoder 60 under the updated encoding condition. In step S610, sound data restored from the encoded data is similarly evaluated by the quality evaluator 80. In step S611, it is determined whether an evaluation value obtained by the evaluation exceeds a threshold value determined in accordance with the current free capacity of the storage 20.

If the quality evaluator 80 determines that the evaluation value exceeds the threshold value (Yes in step S611), in step S612, the encoded data is stored in the storage 20, and the process finishes. If the quality evaluator 80 determines that the evaluation value is equal to or less than the threshold value (No in step S611), similarly, updating of the encoding condition so that the quality increases is repeated by the condition selector 50 until the evaluation value exceeds the threshold value. If a bit rate beyond that accommodated by the current free capacity of the storage 20 is needed during the repetition, an error occurs.

According to the first embodiment, sets of a sampling frequency and a bit rate corresponding to amounts of free space in a storage for storing encoded data are held and one of the sets of a sampling frequency and a bit rate is selected as an encoding condition on the basis of a current free capacity that is an amount of free space currently available in the storage. Sound data included in the music file generated from the digital signal data recorded on the CD-DA is encoded under the selected encoding condition. Sound data restored from the encoded data is evaluated with an evaluation method considering human subjectivity and it is determined whether the result of evaluation exceeds a predetermined threshold value. The encoded data is stored in the storage only when the evaluation result of the sound data restored from the encoded data exceeds the predetermined threshold value. Thus, the encoding apparatus according to the first embodiment of the present invention can simply and flexibly conform to the amount of free space in the storage and perform encoding while ensuring quality that is good enough to be appreciated.

According to first embodiment of the present invention, stored encoding conditions are based not only on amounts of free space in the storage but also on frequency domains of the contents to be encoded. A frequency analysis on a content to be encoded is performed and a current encoding condition is determined depending on the frequency domain of the content and the current free capacity. Thus, the encoding apparatus can more flexibly conform to the amount of free space in the storage. In other words, since an encoding condition is more specifically determined while ensuring quality that is good enough to be appreciated, the encoding apparatus can more flexibly conform to the amount of free space in the storage.

According to the first embodiment of the present invention, the encoding apparatus performs evaluation of the sound data restored from the encoded data while changing the threshold value depending on the current free capacity. Thus, quality control based on the amount of free space is possible. For example, encoded data with good quality may be stored when the amount of free space is large and encoded data with minimum quality may be stored when the amount of free space is small.

According to he first embodiment of the present invention, when the result of evaluation does not exceed the predetermined threshold value, the set of a sampling frequency and a bit rate is adjusted so that the quality increases and the updated set of a sampling frequency and a bit rate is used to encode the content again. When the predetermined threshold value is exceeded in initial determination, the set of a sampling frequency and a bit rate is adjusted so that the quality decreases. Thus, the set of a sampling frequency and a bit rate at which the amount of free space in the storage is used better can be learned.

### Second Embodiment

In the first embodiment of the present invention, a single encoder is used for encoding. In the second embodiment of the present invention, a plurality of encoders with different encoding methods are used for encoding.

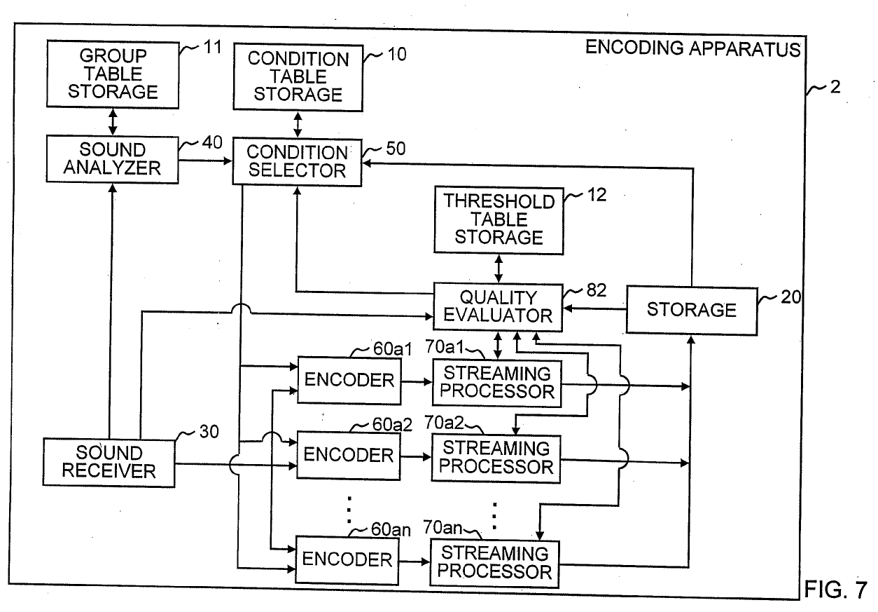

FIG. 7 is a block diagram illustrating a configuration of an encoding apparatus according to a second embodiment of the present invention. The configuration of an encoding apparatus 2 according to the second embodiment will be described with reference to FIG. 7. As shown in FIG. 7, the encoding apparatus 2 includes a condition table storage 10, a storage 20, a sound receiver 30, a sound analyzer 40, a group table storage 11, a condition selector 50, a quality evaluator 82, and a threshold table storage 12. The second embodiment differs from the first embodiment in that it includes a plurality of encoders 60a1 to 60an with different encoding methods and a plurality of streaming processors 70a1 to 70an. Blocks that are identical in operation to those in the first embodiment are denoted by identical reference numerals, and their description is omitted. The encoders 60a1 to 60an, the streaming processors 70a1 to 70an, and the quality evaluator 82 will be described below.

The encoders 60a1 to 60an encode the content to be encoded with different encoding methods under an identical encoding condition. Specifically, after the encoders 60a1 to 60an receive an identical set of a sampling frequency and a bit rate from the condition selector 50, they encode, with different encoding methods, sound data included in a music file received from the sound receiver 30. For example, the encoder 60a1 encodes the sound data included in the music file in an MP3 format, and the encoder 60a2 encodes the sound data included in the music file in an AAC (Advance Audio Coding) format. The encoders 60a1 to 60an output encoded data to the streaming processors 70a1 to 70an, respectively.

The streaming processors 70a1 to 70an restore sound data from the encoded data. Specifically, after receiving the encoded data from the encoders 60a1 to 60an, the streaming processors 70a1 to 70an output the sound data restored from the encoded data to the quality evaluator 82. Among the streaming processors 70a1 to 70an, a streaming processor 70ax that receives an instruction to store the encoded data from the quality evaluator 82 (described later) stores in the storage 20 the encoded data which is actually used for the sound data restoration.

The quality evaluator 82 evaluates sound data restored from each of the encoded data with an evaluation method considering human subjectivity, and determines whether all the evaluation results exceed a predetermined threshold value. Only in a case in which all the evaluation results of sound data restored from the encoded data exceed the threshold value, the quality evaluator 82 determines to store in the storage 20 only one encoded data (among the encoded data) that obtains the highest evaluation result.

Specifically, after receiving the sound data from each of the streaming processors 70a1 to 70an, the quality evaluator 82 uses the PEAQ evaluation method to calculate each evaluation value on the basis of the sound data included in the music file received from the sound receiver 30. The quality evaluator 82 acquires current free capacity from the storage 20, determines a threshold value from the threshold table stored in the threshold table storage 12, and compares each evaluation value with the threshold value. When all the evaluation values exceed the threshold value, the quality evaluator 82 outputs, to the condition selector 50, an instruction to update the encoding condition embedded in a cell from which the selected encoding condition has been actually read so that quality decreases, and outputs, to the streaming processor 70ax that has been output the sound data having the highest evaluation value, a signal instructing the streaming processor 70ax to store in the storage 20 the encoded data actually used for sound data restoration.

When even one of the evaluation values is equal to or less than the threshold value, the quality evaluator 82 outputs, to the condition selector 50, a signal instructing the condition selector 50 to update the encoding condition embedded in the cell from which the selected encoding condition has been actually read so that the quality increases.

According to the second embodiment of the present invention, a plurality of encoders with different encoding methods encode a content under an identical encoding condition. Each of sound data restored from the encoded data is evaluated with an evaluation method considering human subjectivity, and it is determined whether all evaluation results exceed a predetermined threshold value. Only in a case in which the evaluation results of all the sound data restored from the encoded data exceed the predetermined threshold value, only one encoded data (among all the encoded data) that obtains the highest evaluation result is stored in the storage. Thus, the encoded data having optimal quality among all the encoded data can be selected.

### Other Embodiments

The embodiments of the present invention have been described. The present invention may be practiced in various different forms other than the above embodiments. Accordingly, different embodiments will be described below.

In the above-described first embodiment, frequencies of sound data included in the music file generated from the digital signal data are analyzed and encoding is performed under an encoding condition corresponding not only to an amount of free space but also to the analysis result. However, the present invention is not limited to the case, and encoding may be performed under an encoding condition corresponding only to the amount of free space without using the frequency analysis result. Even in this case, an encoding apparatus can simply and flexibly conform to the amount of free space in the storage and can perform encoding while ensuring quality that is good enough to be appreciated.

In the above-described first embodiment, a threshold value for comparison with an evaluation value changes depending on an amount of free space in a storage. However, the present invention is not limited to the case. Any method can be performed if quality that is good enough to be appreciated is ensured. For example, a constant threshold value may be maintained regardless of the amount of free space.

In the above-described first embodiment, an encoding condition is updated so that quality increases until an evaluation value exceeds a threshold value, and when the evaluation value exceeds the threshold value in initial determination, the encoding condition is updated so that the quality decreases. However, the present invention is not limited to the case. It does not necessarily need to update the encoding condition.

In the above-described first embodiment, the content to be encoded is sound data. However, the present invention is not limited to the case. The content to be encoded may be any digital data that is provided to a user for enjoyment. The present invention can be applied to, for example, moving images and still images.

In addition, components of the apparatuses shown in the drawings are functionally conceptual and do not always need to be physically formed as illustrated. In other words, specific distributed and integrated forms of each apparatus are not limited to the shown forms. For example, all or part of each component can be functionally or physically configured in distributed and integrated forms depending on various types of loads and a status of use, etc., in arbitrary units, such as integration of the sound receiver 30 and the sound analyzer 40. All or part of each processing function performed by each apparatus can be realized by a CPU (central processing unit) and a program that is interpreted and executed by the CPU, or can be realized in the form of wired logic hardware.

Among the processes described in the foregoing embodiments, all or part of automatically performed processes can be manually performed, or all or part of manually performed processes can be automatically performed by a method of the related art. For example, in the first embodiment, upon loading a CD-DA, the sound receiver 30 automatically generates a music file. However, the music file may be generated in response to a user's predetermined operation. In addition, information shown in the above description and drawings including process procedures, control procedures, specific names, and various types of data and parameters, such as group IDs “S1” and “S2”, can arbitrarily be changed unless otherwise specified.

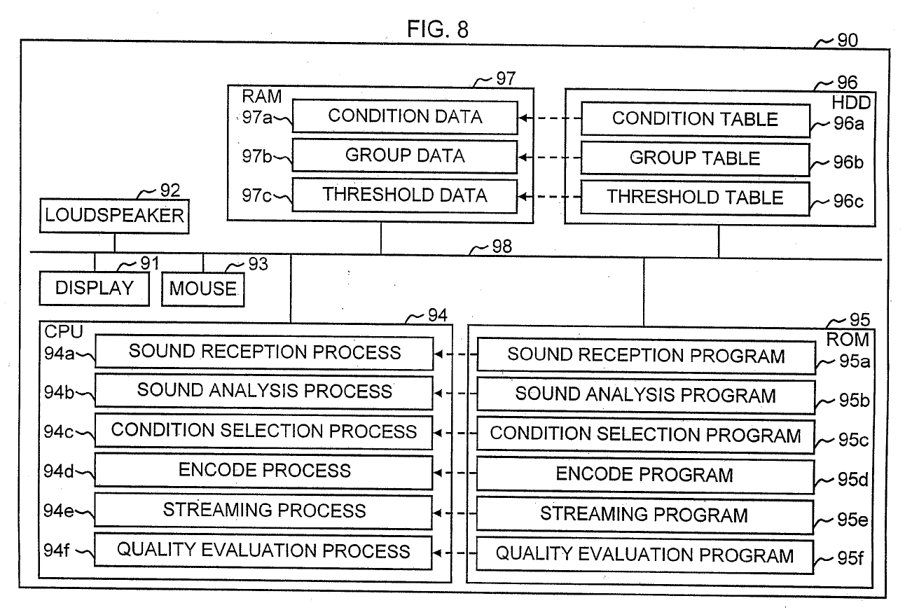

In the first embodiment, various types of processes are realized by hardware logic. However, the present invention is not limited to the case. The processes may be realized by allowing a computer to execute a prepared program. FIG. 8 is a block diagram illustrating a computer for executing an encoding program according to an embodiment of the present invention. An example of a computer 90 for executing an encoding program having functions similar to those of the encoding apparatus 1 according to the first embodiment will be described below.

As shown in FIG. 8, the computer 90 as an encoding apparatus includes a display 91, a loudspeaker 92, a mouse 93, a CPU 94, a ROM (read-only memory) 95, an HDD (hard disk drive) 96, and a RAM (random access memory) 97 connected each other via a bus 98 or the like.

The ROM 95 stores beforehand an encoding program including subprograms providing functions similar to those of the encoding apparatus 1 according to the first embodiment, that is, as shown in FIG. 8, a sound reception program 95a, a sound analysis program 95b, a condition selection program 95c, an encode program 95d, a streaming program 95e, and a quality evaluation program 95f. These subprograms 95a to 95f may be integrated or distributed, if necessary, similarly to the components of the encoding apparatus 1 shown in FIG. 2.

The CPU 94 reads the subprograms 95a to 95f from the ROM 95 and executes the subprograms, whereby, as shown in FIG. 8, the CPU 94 can function as a sound reception process 94a, a sound analysis process 94b, a condition selection process 94c, an encode process 94d, a streaming process 94e, and a quality evaluation process 94f. The processes 94a to 94f respectively correspond to the sound receiver 30, the sound analyzer 40, the condition selector 50, the encoder 60, the streaming processor 70, and the quality evaluator 80 shown in FIG. 2.

In addition, as shown in FIG. 8, the HDD 96 stores a condition table 96a, a group table 96b, and a threshold table 96c. The condition table 96a, the group table 96b, and the threshold table 96c respectively correspond to the condition table stored in the condition table storage 10, the group table stored in the group table storage 11, and the threshold table stored in the threshold table storage 12 shown in FIG. 2. The CPU 94 reads condition data 97a, group data 97b, and threshold data 97c from the condition table 96a, the group table 96b, and the threshold table 96c, respectively, and stores the read data in the RAM 97. The CPU 94 performs encoding on the basis of the condition data 97a, the group data 97b, and the threshold data 97c stored in the RAM 97.

The subprograms 95a to 95f do not necessarily need to be stored in the ROM 95 from the beginning. For example, each subprogram may be stored in a “portable physical medium” inserted into the computer 90, such as an FD (flexible disk), a CD-ROM (compact-disc read-only memory), an MO (magneto-optical) disc, a DVD (digital versatile disc), or an IC (integrated circuit) card, in a “fixed physical medium” such as an HDD provided inside or outside the computer 90, or in a “different computer (or a server)” connected to the computer 90 via a public circuit, the Internet, a IAN (local area network), or a WAN (wide area network). The computer 90 may read and execute the program in the medium.

As described above, an encoding apparatus according to the present invention is useful in encoding a content to be encoded. In particular, the encoding apparatus according to the present invention can simply and flexibly conform to an amount of free space in a storage and perform encoding while ensuring quality that is good enough to be appreciated.

What is claimed is:

1. An encoding apparatus for encoding contents, comprising:
a content storage for storing encoded contents generated by encoding the contents;
a condition storage for storing conditions corresponding to amounts of free space in the content storage;
an input unit for input a content;
a condition selector for retrieving a current condition from among the conditions stored in the condition storage, said current condition corresponding to a current free capacity which is an amount of free space currently available in the content storage;
an encoder for encoding the content under the current condition;
a restorer for restoring a content from the encoded content;
an evaluator for
evaluating the restored content, and
determining whether the evaluation result exceeds a predetermined threshold; and
a manager for storing the encoded content in the content storage when the evaluation result exceeds the predetermined threshold.

2. The encoding apparatus of claim 1, further comprising:
an analyzer for determining a frequency domain of the content, wherein
said conditions stored in the condition storage also correspond to frequency domains of contents, and
said condition selector retrieves a current condition also corresponding to the frequency domain of the content.

3. The encoding apparatus of claim 1, wherein
said encoder encodes the content with a plurality of encoding methods,
said restorer restores a plurality of contents from a plurality of the encoded contents,
said evaluator
evaluates a plurality of the restored contents, and
determines whether all the evaluation results exceed the predetermined threshold, and
said manager stores in the content storage an encoded content corresponding to a restored content with a highest evaluation result when all the evaluation results exceed the predetermined threshold.

4. The encoding apparatus of claim 1, wherein
said predetermined threshold varies in accordance with the current free capacity.

5. The encoding apparatus of claim 1, further comprising:
a condition updater for updating the current condition,
said update including adjustment of the current condition as to increase a quality of the restored content when the evaluation result is within the predetermined threshold,
said update including adjustment of the current condition as to decrease the quality of the restored content when the evaluation result exceeds the predetermined threshold in an initial determination,
wherein
said encoder encodes the content under the updated current condition when the evaluation result is within the predetermined threshold.

6. A computer readable storage medium storing a program of instructions to a computer for executing an encoding method for encoding contents, said computer including a content storage for storing encoded contents generated by encoding the contents, said computer including a condition storage for storing conditions corresponding to amounts of free space in the content storage, the encoding method comprising the steps of:
inputting a content;
retrieving a current condition from among the conditions stored in the condition storage, said current condition corresponding to a current free capacity which is an amount of free space currently available in the content storage;
encoding the content under the current condition;
restoring a content from the encoded content;
evaluating the restored content;
determining whether the evaluation result exceeds a predetermined threshold; and
storing the encoded content in the content storage when the evaluation result exceeds the predetermined threshold.

7. An encoding method executed by an encoding apparatus for encoding contents, said encoding apparatus including a content storage for storing encoded contents generated by encoding the contents, said encoding apparatus including a condition storage for storing conditions corresponding to amounts of free space in the content storage, the encoding method comprising the steps of:
inputting a content;
retrieving a current condition from among the conditions stored in the condition storage, said current condition corresponding to a current free capacity which is an amount of free space currently available in the content storage;
encoding the content under the current condition;
restoring a content from the encoded content;
evaluating the restored content;
determining whether the evaluation result exceeds a predetermined threshold; and
storing the encoded content in the content storage when the evaluation result exceeds the predetermined threshold.
